(19) United States
(12) Patent Application Publication
(10) Pub. No.: US 2024/0418231 A1
(43) Pub. Date: Dec. 19, 2024

(54) DAMPER VALVE DEVICE FOR A VIBRATION DAMPER

(71) Applicant: ZF Friedrichshafen AG, Friedrichshafen (DE)

(72) Inventors: Jörg RÖSSELER, Ruppichteroth (DE); Aleksandar KNEZEVIC, Eitorf (DE); Martin MALLON, Eitorf (DE)

(21) Appl. No.: 18/733,150

(22) Filed: Jun. 4, 2024

(30) Foreign Application Priority Data
Jun. 13, 2023 (DE) 10 2023 205 447.7

(51) Int. Cl. F16F 9/348

(52) U.S. Cl. CPC F16F 9/3482; F16F 9/3484; F16F 9/3485

(57) ABSTRACT

A throttle point for a vibration damper, having a valve support with an annular groove, in which an annular valve element with a variable diameter is arranged, which, together with a flow guide surface, forms a throttle point. With increasing flow velocity within the throttle point, the valve element switches from an open position to a throttle position, and an annular and slotted return spring, which rests against a vertical lateral surface of the valve element and has two impacting ends, moves the valve element back in the direction of the open position, wherein the vertical lateral surface has at least one radially oriented recess for receiving one of the impacting ends.

### BACKGROUND OF THE INVENTION

### 1. Field of the Invention

The disclosure relates to a throttle point for a vibration damper.

### 2. Description of Related Art

A generic throttle point, which comprises an annular valve element and, starting from an open position, assumes a throttle position by a change in diameter, is known from DE 10 2019 215 559 A1. The annular valve element may, for example, be formed by a slotted ring made of metal or plastics material, or at least two arms connected by an articulation or a plurality of segments (cf. DE 10 2016 210 790 A1; DE 10 2019 215 558 A1; DE 10 2020 209 107 A1).

In particular in valve element configurations with no inherent elasticity, a return spring is provided, which moves the valve element from any throttle position back to the open position. A particularly simple construction of the return spring is provided by a slotted ring, which rests against a lateral surface of the valve element. When resting against the lateral surface, the return spring may rotate in the circumferential direction relative to the valve element while the throttle point is in operation, and may thus change the characteristics of the throttle point.

DE 10 2019 215 559 A1 describes a friction-optimized configuration of the generic throttle point. The variant shown in FIGS. 7 and 8 has a return spring arranged on a cover side of the valve element. To fasten the return spring in position, the latter has angled ends which each engage in a blind hole opening per arm of the valve element. Although the return spring is secured in a non-rotational manner, the conventional spring steel used for the return spring is poorly suited to this type of metal forming, since there is an increased risk of cracking in the region of the bend radius.

### SUMMARY OF THE INVENTION

An object of one aspect of the present invention is to achieve a simple manner for securing the return spring in a non-rotational manner relative to the valve element.

One aspect of the invention is that a vertical lateral surface has at least one radially oriented recess for receiving one of the impacting ends.

The at least one recess ensures that the return spring is obstructed in a circumferential direction. This obstruction on one side/on a single side is sufficient to adequately secure the position of the return spring relative to the valve element. Due to the radial orientation of the recess, the return spring is automatically drawn into the recess as a result of its own tension. The actuating force of the return spring and the radial form of the recess have a common orientation.

In a further advantageous configuration, the valve element has a plurality of recesses arranged in a row for the at least one impacting end of the return spring. Should the return spring move in the circumferential direction relative to the valve element despite engaging in a first recess, a second recess is provided to prevent further rotational movement.

It is provided that two recesses in the valve element for the two impacting ends of the return spring move relative to each other as the diameter of the valve element changes, wherein the circumferential distance between a first recess and a second recess is dimensioned in such a way that only one end face of the impacting end of the return spring comes to rest in one of the recesses. It is thus intended that the return spring has a certain amount of clearance in the circumferential direction relative to the valve element in order to positively influence the distribution of tension within the return spring.

Preferably, the radial depth of the recesses in the valve element decreases with increasing distance from the adjacent impacting ends. A shallower radial depth of a recess leads to greater radial bias of the return spring, which is reduced/relieved by the return spring widening fractionally and the impacting ends being positioned somewhat further apart. This assists the impacting ends to dip into the first adjacent recess.

According to an advantageous aspect of the invention, the valve element comprises a plurality of segments with an identical basic shape, wherein the segments have at least two recesses which are oriented in an opposite direction.

In a further advantageous construction, in the direction of an axial cover side of the valve element, the at least one recess has a closure which may be formed for example by an annular groove side wall of the valve support.

Preferably, the closure forms part of the valve element. A sub-assembly consisting of the valve element and the return spring is therefore secured axially before the sub-assembly is inserted into the valve support.

### BRIEF DESCRIPTION OF THE DRAWINGS

The invention will be explained in greater detail on the basis of the following description of the figures.

In the drawings:

FIG. 1 is a sectional view through a vibration damper in the region of the throttle point;

FIG. 2 is a sectional view through the valve support according to FIG. 1;

FIG. 3 is a plan view of the valve element comprising the return spring according to FIG. 1; and

FIG. 4 is a modification of the configuration according to FIG. 2.

### DETAILED DESCRIPTION OF THE PRESENTLY PREFERRED EMBODIMENTS

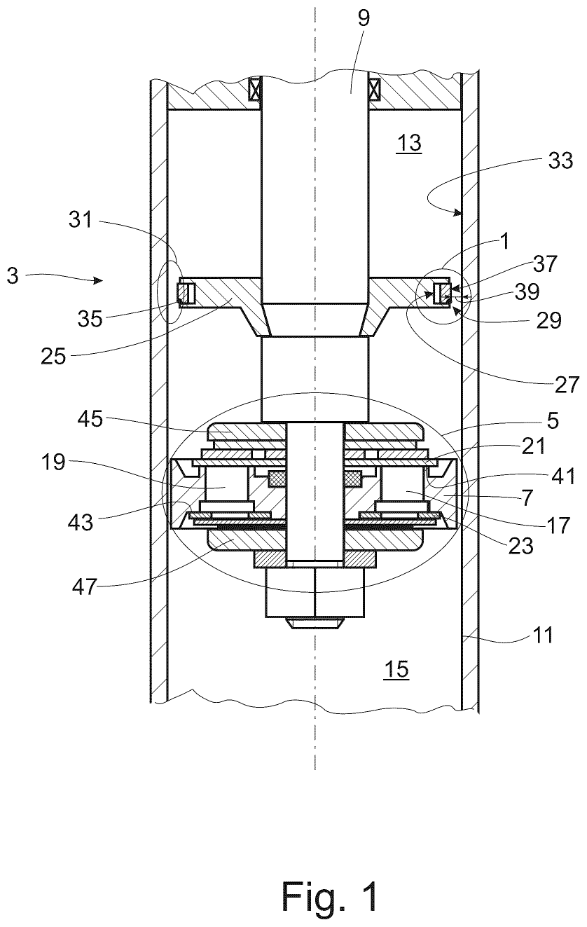

FIG. 1 shows a damper valve device 1 for a vibration damper 3 of any type (only shown in part). In addition to the damper valve device 1, the vibration damper 3 comprises a first damper valve 5 with a damper valve body, which is configured as a piston 7 and is fastened to a piston rod 9.

The damper valve body 7 divides a cylinder 11 of the vibration damper 3 into the working chambers 13; 15, one on the piston rod side and one remote from the piston rod, both of which are filled with damping medium. In the damper valve body 7, passage channels 17; 19 are configured for one flow direction in each case, in different partial circuits. The construction of the passage channels 17; 19 is to be construed as exemplary only. An outlet side of the passage channels 17; 19 is covered at least in part by at least one valve disk 21; 23.

By way of example, a valve support 25 of the damper valve device 1 is fastened directly to the piston rod 9.

The valve support 25 has a circumferential annular groove 27, in which a valve element 29 with a variable diameter is guided. This valve element 29 is radially movable and forms a valve body for a throttle point 31 as part of the damper valve device 1. The valve element 29, together with an inner wall of the cylinder 11, forms the throttle point 31, wherein the inner wall represents a flow guide surface 33.

The valve element 29 is fitted with an annular return spring 35. Provided between the flow guide surface 33 and an outer lateral surface 37 of the valve element 29 is a variable throttle cross section 39, which generates an additional damping force.

At a piston rod speed within a first operating range, for example less than 0.5 m/s, the throttle point 31 is fully open. The damping force is in this case generated only by the passage channels 17; 19 in conjunction with the valve disks 21; 23. When the valve disks 21; 23 are subjected to a flow, the valve disks 21; 23 lift off from the valve seat surface 41; 43 thereof. The lifting movement is limited in each case by a support ring 45; 47.

In a second operating range with a piston rod speed greater than the threshold speed of the first operating range, i.e., greater than the 0.5 m/s stated by way of example, the valve element 29 switches to a throttle position and performs a closing movement in the direction of the flow guide surface 33. The high flow velocity of the damping medium in the throttle point 31, formed as an annular gap, leads to reduced pressure, which causes the valve element 29 to expand radially. The return spring 35 returns the valve element 29 to the initial position with the maximum throttle cross section 39.

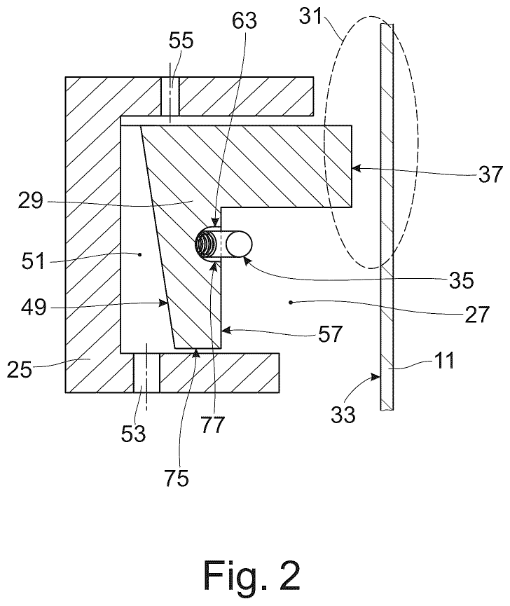

FIG. 2 shows an enlarged view of the damper valve device 1. An inner lateral surface 49 of the valve element 29 and the annular groove 27 of the valve support 25 form a pressure chamber 51, which is delimited at the outer edge by the valve element 29. The pressure chamber 51 is connected to the working chamber 13 on the piston rod side via an inflow opening 53 and an outflow opening 55. In principle, it would also be possible to arrange the damper valve device 1 so as to be hydraulically coupled to the working chamber 15 remote from the piston rod. The pressure chamber 51 is permanently filled with damping medium. When the throttle point 31 is subjected to a flow, the pressure chamber 51 is pressurized via the inflow opening 53, since the cross section of the inflow opening 53 is greater than that of the outflow opening 55. The difference in size between the inflow opening 53 and the outflow opening 55 is determined in accordance with the damping force function required. The pressure within the pressure chamber 51 provides an additional force component that assists the travel of the valve element 29.

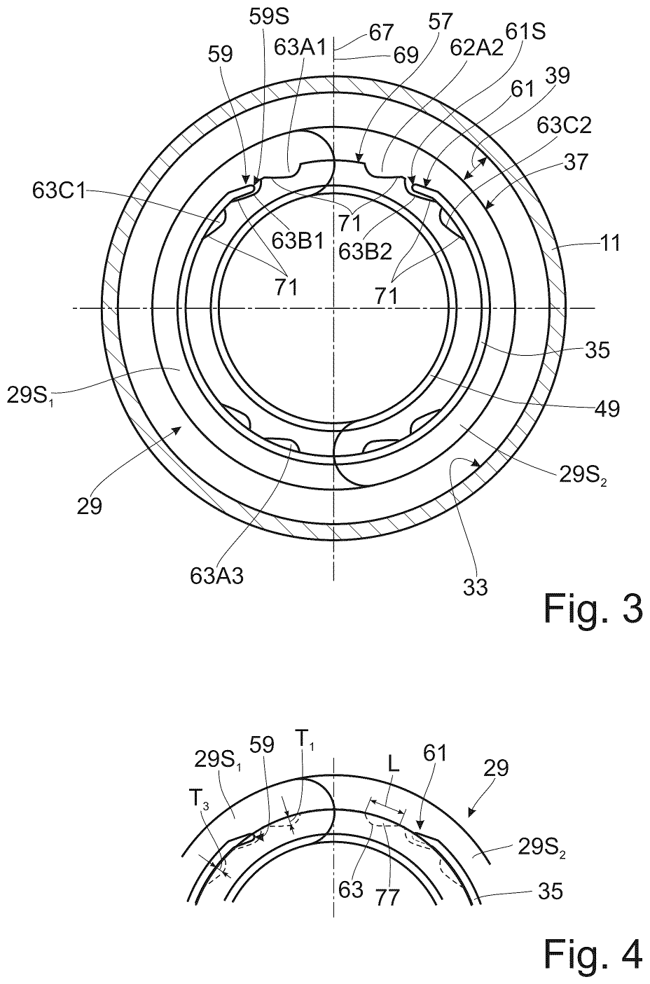

Viewing FIGS. 2 and 3 in combination shows that the annular and slotted return spring 35, which rests against a vertical lateral surface 57 of the valve element 29, has two impacting ends 59; 61. The vertical lateral surface 57, which extends in a radially offset manner from the outer lateral surface 37 of the valve element 29, has at least one radially oriented recess 63 for receiving one of the impacting ends 59; 61.

In the configuration according to FIGS. 3 and 4, the valve element 29 has a plurality of recesses 63A1-63C1; 63A2-63C2 arranged in a row for the at least one impacting end 59; 61 of the return spring 35. The recesses 63 arranged in a row need not necessarily be identical in length or depth. Preferably, the radial depth T of the recesses in the valve element decreases with increasing distance from the adjacent impacting ends. The circumferential length L of the recesses is greater than the depth T thereof, resulting in a continuous transition between the vertical lateral surface 57 and the recesses 63 within vertical lateral surface 57.

The main aim of securing the return spring 35 in a non-rotational manner via the recesses 63 is not to fix the return spring 35 without clearance between the engaged recesses 63. Rather, it is provided that the two engaged recesses, for example 63B1; 63B2, in the valve element 29 for the two impacting ends 59; 61 of the return spring 35 move relative to each other as the diameter of the valve element 29 changes, wherein the circumferential distance between a first recess 63B1 and a second recess 63B2 is dimensioned in such a way that only one end face 59S; 61S of the impacting end 59; 61 of the return spring 35 comes to rest in one of the recesses 63B1; 63B2. The other end face is in this case not fixed in the recess, but the return spring 35 is able to dip into the recess via the inner circumference 65 thereof.

In the present configuration, the valve element 29 comprises a plurality of segments 29S₁; 29S₂ having an identical basic shape. The aim is to use segments which are as uniform as possible to minimize the costs of the valve element 29 and to ensure that it is not necessary for example to use two tools to manufacture the segments. To allow the segments 29S₁; 29S₂ to be used in any desired combination, the segments 29S₁; 29S₂ have at least two recesses 63A1; 63A3 which are oriented in an opposite direction. With respect to the return spring 35, which fixes the two segments 29S₁; 29S₂ together, a bisector of the return spring 35 is to be congruent with a vertical main axis 69 of the valve element. In this aspect, the vertical main axis tangentially connects a convex end of one segment to the convex end of the other segment. The entrance side 71 of the recesses 63 of the segments 29S₁; 29S₂ points in each case towards a horizontal main axis 73, which in this exemplary aspect extends at right angles to the vertical main axis 69.

The return spring 35 is also secured against falling axially out of the at least one recess 63 holding the return spring 35. For this purpose, the at least one recess 63 has a closure 77 in the direction of an axial cover side 75 of the valve element 29. The closure 77 forms part of a wall of the cover side 75 of the valve element 29, as illustrated by viewing FIGS. 2 and 4 in combination.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A damper valve device for a vibration damper, comprising:
a valve support with an annular groove;
an annular valve element with a variable diameter is arranged in the annular groove, which, together with a flow guide surface, forms a throttle point;
wherein, with increasing flow velocity within the throttle point, the annular valve element switches from an open position to a throttle position; and
an annular and slotted return spring, which rests against a vertical lateral surface of the annular valve element and having two impacting ends, moves the annular valve element back in a direction of the open position,
wherein the vertical lateral surface has at least one radially oriented recess for receiving one of the two impacting ends.

2. The damper valve device as claimed in claim 1, wherein the annular valve element has a plurality of recesses arranged in a row for at least one of the two impacting ends of the return spring.

3. The damper valve device as claimed in claim 2, wherein two recesses in the annular valve element for the two impacting ends of the return spring move relative to each other as the variable diameter of the annular valve element changes, wherein a circumferential distance between a first recess and a second recess is dimensioned such that only one end face of the impacting end of the return spring comes to rest in one of the recesses.

4. The damper valve device as claimed in claim 3, wherein a radial depth of the recesses in the annular valve element decreases with increasing distance from adjacent impacting ends.

5. The damper valve device as claimed in claim 1, wherein the annular valve element comprises a plurality of segments with an identical basic shape, wherein the plurality of segments have at least two recesses which are oriented in opposite directions.

6. The damper valve device as claimed in claim 1, wherein the at least one recess has a closure in the direction of an axial cover side of the annular valve element.

7. The damper valve device as claimed in claim 6, wherein the closure forms part of the annular valve element.
